(19) United States
(12) Patent Application Publication
(10) Pub. No.: US 2006/0031072 A1
(43) Pub. Date: Feb. 9, 2006

(54) Electronic dictionary apparatus and its control method

(76) Inventors: Yasuo Okutani, Kawasaki-shi (JP); Michio Aizawa, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/197,268

(22) Filed: Aug. 4, 2005

(30) Foreign Application Priority Data
Aug. 6, 2004 (JP) 2004-231425

(51) Int. Cl. G10L 13/08

(52) U.S. Cl. 704/260

(57) ABSTRACT

An electronic dictionary apparatus and its control method are provided. A database contains entry words and advanced phonetic information corresponding to each entry word. A dictionary search section searches the database using an entry word specified by a user as a search key and acquires the advanced phonetic information corresponding to the entry word. A display section displays simple phonetic information generated based on the acquired advanced phonetic information. A speech output section performs speech synthesis based on the acquired advanced phonetic information and outputs the synthesized speech.

### FIELD OF THE INVENTION

The present invention relates to an electronic dictionary apparatus, and more particularly to an electronic dictionary apparatus with speaking facility.

### BACKGROUND OF THE INVENTION

In electronic dictionaries, displayed information about a word typically includes its definitions and parts of speech, as well as its phonetic information. IPA (International Phonetic Alphabet) is a representative of advanced phonetic symbol sets that can accurately describe pronunciation (for example, see “Handbook of the International Phonetic Association,” CAMBRIDGE UNIVERSITY PRESS).

Phonetic symbols that appear in dictionaries are typically a simplified variation (referred to as “simple phonetic symbols” hereafter) of the IPA phonetic symbols. In this simplification process, information is often omitted such as whether there is aspiration, whether it is voiced or voiceless, nasalization, etc.

FIG. 5 shows an example of advanced phonetic symbols and simple phonetic symbols. The simple phonetic symbol set has a disadvantage, for example that it cannot distinguish between [h] in the word “he” and [h] in the word “ahead.” On the other hand, since the simplification has decreased the number of kinds of phonetic symbols, it has an advantage that a dictionary user can more easily understand the phonetic symbols. For illustrative simplicity, stress symbols have been omitted in FIG. 5.

Further, in recent years, electronic dictionaries have been commercially available that have speaking facility for outputting speech corresponding to entry words. For those electronic dictionaries that reproduce prerecorded speech, an enormous amount of memory space is required for storing speech data. Therefore, electronic dictionaries of this type often store speech data for only important words to save memory space. Another type of commercially available electronic dictionaries use speech synthesis technique to generate and output synthesized speech. Since electronic dictionaries of this type need not store prerecorded speech for entry words, they require less memory space, and moreover, they can read out any entry word.

However, phonetic information stored in an electronic dictionary and phonetic dictionary for speech synthesis are usually developed independently of each other. Therefore, pronunciation of speech generated by speech synthesis may not match displayed phonetic symbols. This mismatch may confuse those who are learning pronunciation or make them learn wrong pronunciation.

In this regard, an attempt is made in Japanese Patent Laid-Open No. 04-218871 to prevent wrong pronunciation by performing speech synthesis using phonetic symbol information stored in a dictionary.

However, since the method described in the Japanese Patent Laid-Open No. 04-218871 uses simple phonetic symbols stored in the dictionary, the method cannot obtain enough information required for speech synthesis (whether there is aspiration, whether it is voiced or voiceless, nasalization, etc.). Therefore, the problem of low quality synthesized speech arises.

### SUMMARY OF THE INVENTION

In view of the above problems in the conventional art, the present invention has an object, in an electronic dictionary apparatus that displays phonetic symbols for a specified entry word and outputs speech for the entry word by speech synthesis, to prevent occurrence of mismatch between the displayed phonetic symbols and the output speech and to improve the quality of the synthesized speech.

In one aspect of the present invention, an electronic dictionary apparatus is provided. The apparatus includes a storage means for storing a plurality of entry words and advanced phonetic information corresponding to each of the plurality of entry words, an acquisition means for acquiring the advanced phonetic information corresponding to an entry word specified by a user from the storage means, a display means for displaying of simple phonetic information generated based on the acquired advanced phonetic information, and a speech output means for performing speech synthesis based on the acquired advanced phonetic information and outputting the synthesized speech.

In another aspect of the present invention, a method for controlling an electronic dictionary apparatus is provided. The method includes the steps of acquiring advanced phonetic information corresponding to an entry word specified by a user from a storage means that contains entry words and advanced phonetic information corresponding to each entry word, displaying simple phonetic information generated based on the acquired advanced phonetic information on a display, and performing speech synthesis based on the acquired advanced phonetic information and outputting the synthesized speech.

The above and other objects and features of the present invention will appear more fully hereinafter from a consideration of the following description taken in connection with the accompanying drawing wherein one example is illustrated by way of example.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing a hardware configuration of an information processing apparatus in a first embodiment;

FIG. 2 is a block diagram showing a modular configuration of an electronic dictionary program in the first embodiment;

FIG. 3 is a flowchart showing a flow of display processing by the electronic dictionary program according to the first embodiment;

FIG. 4 is a flowchart showing a flow of speech output processing by the electronic dictionary program according to the first embodiment; and

FIG. 5 shows an example of advanced phonetic symbols and simple phonetic symbols.

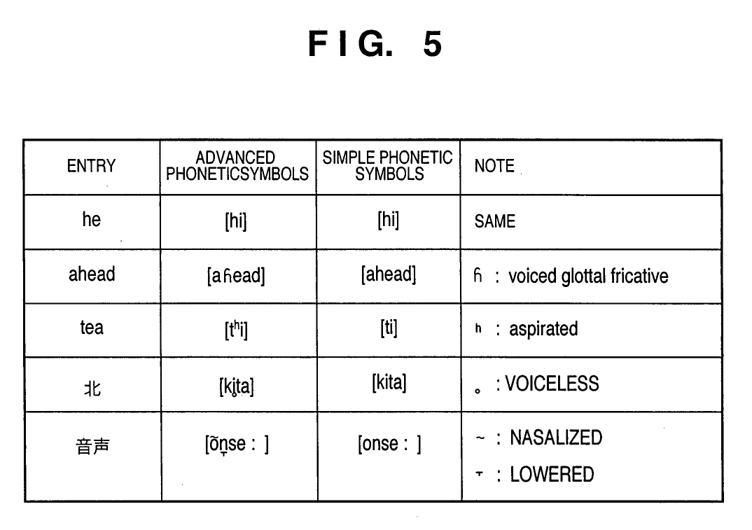

### DETAILED DESCRIPTION OF THE PREFERRED EMBODIMENTS

Preferred embodiment(s) of the present invention will be described in detail in accordance with the accompanying drawings. The present invention is not limited by the disclosure of the embodiments and all combinations of the features described in the embodiments are not always indispensable to solving means of the present invention.

An electronic dictionary apparatus according to the present invention can be implemented by a computer system (information processing apparatus). That is, the electronic dictionary apparatus according to the present invention can be implemented in a general-purpose computer such as a personal computer or a workstation, or implemented as a computer product specialized for electronic dictionary functionality.

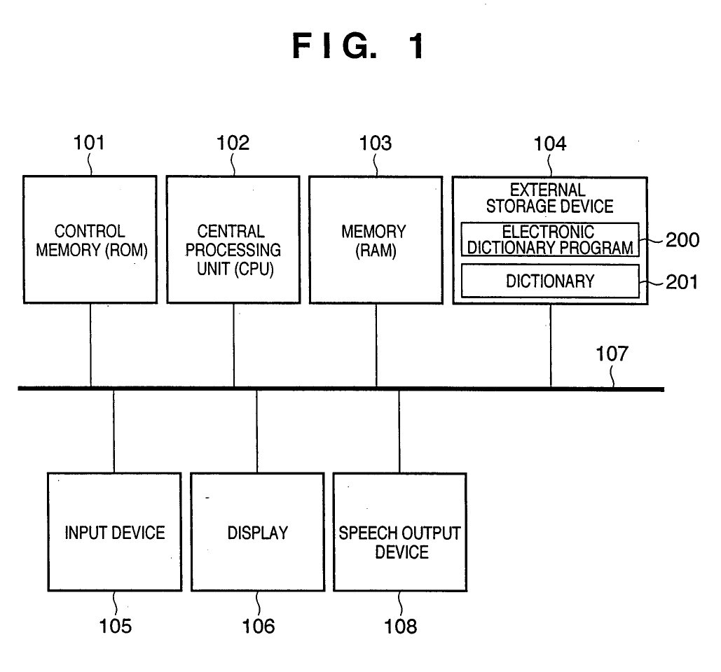

FIG. 1 is a block diagram showing a hardware configuration of the electronic dictionary apparatus with speaking facility in the present embodiment. In this figure, reference numeral 101 denotes control memory (ROM) that stores control programs and data necessary for activating the apparatus; reference numeral 102 denotes a central processing unit (CPU) responsible for overall control on the apparatus; reference numeral 103 denotes memory (RAM) that functions as main memory; reference numeral 104 denotes an external storage device such as a hard disk; reference numeral 105 denotes an input device such as a keyboard; reference numeral 106 denotes a display such as LCD or CRT; reference numeral 107 denotes a bus; and reference numeral 108 denotes a speech output device including a D/A converter, a loudspeaker, and so on.

The external storage device 104 stores an electronic dictionary program 200, a dictionary 201 as a database, and so on, for implementing the electronic dictionary functionality according to this embodiment. Alternatively, the electronic dictionary program 200 and the dictionary 201 may be stored in the ROM 101 instead of the external storage device 104. The electronic dictionary program 200 is appropriately loaded into the RAM 103 via the bus 107 under the control of the CPU 102 and executed by the CPU 102.

The dictionary 201 has a data structure that contains, for example, entry words, their definitions, as well as advanced phonetic information that conforms to IPA (International Phonetic Alphabet). Of course, the data structure may also contain other information, for example parts of speech and examples for each entry word.

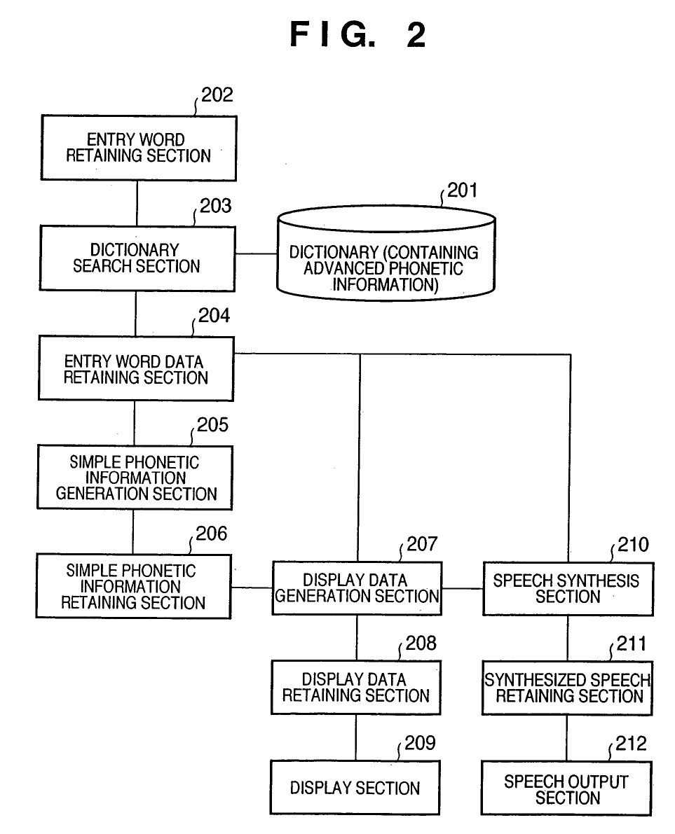

FIG. 2 is a block diagram showing a modular configuration of the electronic dictionary program 200 in this embodiment. An entry word retaining section 202 retains an entry word specified by a user via the input device 105. A dictionary search section 203 searches the dictionary 201 using the entry word as a search key. An entry word data retaining section 204 retains a dictionary search result. A simple phonetic information generation section 205 generates simple phonetic information from the advanced phonetic information. A simple phonetic information retaining section 206 retains the generated simple phonetic information. A display data generation section 207 generates display data from the entry word data and the simple phonetic information. A display data retaining section 208 retains the display data. A display section 209 displays the display data on the display 106. A speech synthesis section 210 generates synthesized speech from the advanced phonetic information. A synthesized speech retaining section 211 retains the synthesized speech. A speech output section 212 outputs the speech to the speech output device 108.

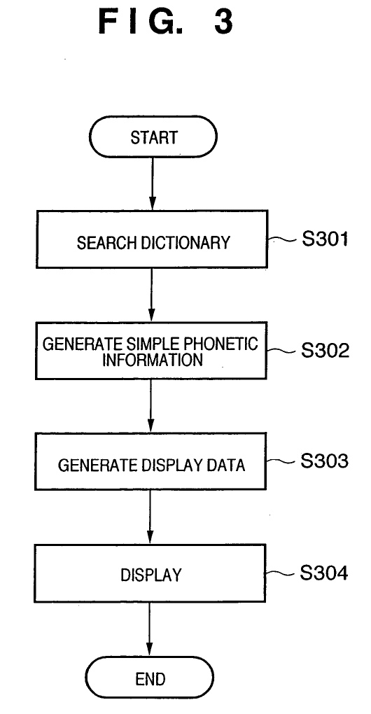

FIG. 3 is a flowchart showing a flow of dictionary data display processing performed by the electronic dictionary program 200 according to this embodiment. Here, processing after a user has specified an entry word via the input device 105 is described. As mentioned above, the specified entry word is retained by the entry word retaining section 202.

First, at step S301, the dictionary search section 203 searches the dictionary 201 using the entry word retained in the entry word retaining section 202 as a search key, and obtains dictionary data corresponding to the entry word. The data is retained in the entry word data retaining section 204, and the processing proceeds to step S302. The entry word data obtained as a result of the search includes definitions and advanced phonetic information.

At step S302, the simple phonetic information generation section 205 extracts the advanced phonetic information from the entry word data retained by the entry word data retaining section 204, and generates simple phonetic information based on the advanced phonetic information. The generated simple phonetic information is retained in the simple phonetic information retaining section 206, and the processing proceeds to step S303. The simple phonetic information can be generated, for example by removing or replacing those advanced phonetic symbols that are not found in simple phonetic symbols.

At step S303, display data is generated from the data, other than the advanced phonetic information, retained by the entry word data retaining section 204 and from the simple phonetic information retained by the simple phonetic information retaining section 206. The display data is retained in the display data retaining section 208, and the processing proceeds to step S304.

At step S304, the display data retained by the display data retaining section 208 is displayed by the display section 209 on the display 106, and the processing terminates.

According to the above processing, the simple phonetic information generated based on the advanced phonetic information corresponding to the entry word is displayed. That is, although the dictionary 201 contains the advanced phonetic information but not the simple phonetic information, simple phonetic symbols can be displayed on the display 106 as with typical electronic dictionaries. Viewed from a user, the displayed phonetic symbols are the same as those displayed on conventional electronic dictionaries. Since the simple phonetic information includes fewer kinds of phonetic symbols than the advanced phonetic information, the user can more easily understand the phonetic symbols.

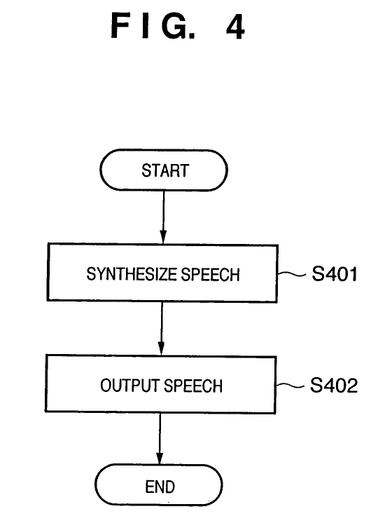

FIG. 4 is a flowchart showing a flow of speech output processing performed by the electronic dictionary program according to this embodiment. In FIG. 4, processing after a user has requested a pronunciation of an entry word via the input device 105 is described.

First, at step S401, the speech synthesis section 210 extracts the advanced phonetic information from the entry word data retained by the entry word data retaining section 204. It then performs speech synthesis based on the advanced phonetic information. Therefore, enough information for speech synthesis (whether there is aspiration, whether it is voiced or voiceless, nasalization, etc.) can be obtained, so that higher quality speech can be synthesized compared to speech synthesis using the simple phonetic information. The synthesized speech data resulting from this speech synthesis is retained in the synthesized speech retaining section 211.

At step S402, the speech output section 212 outputs the synthesized speech data retained in the synthesized speech retaining section 211 to the speech output device 108, and the processing terminates.

According to the processing described using the above flowcharts in FIGS. 3 and 4, the phonetic information displayed on the display is the simple phonetic information generated based on the advanced phonetic information corresponding to the entry word. On the other hand, the speech of the entry word is output as the synthesized speech based on its advanced phonetic information. Therefore, no mismatch occurs between the displayed phonetic information and the output speech, so that it is possible to avoid problems such as confusing the user. Moreover, as described above, since the speech synthesis is performed based on the advanced phonetic information, the synthesized speech of higher quality can be obtained than in conventional speech synthesis that is based on the simple phonetic information.

In the above described embodiments, the dictionary 201 has a data structure that contains the advanced phonetic information. However, the advanced phonetic information does not necessarily have to be registered in the dictionary 201. Instead, it may be retained as a database (referred to as an “advanced phonetic information retaining section” hereafter) outside the dictionary 201. In that case, the dictionary search section 203 will search each of the dictionary 201 and the advanced phonetic information retaining section to extract the dictionary data and advanced phonetic information corresponding to the entry word. The speech synthesis section 210 will obtain the advanced phonetic information from the advanced phonetic information retaining section and perform the speech synthesis based on the advanced phonetic information.

In the above described embodiments, the simple phonetic information is not retained in the dictionary 201 but generated based on the advanced phonetic information. However, the simple phonetic information corresponding to each advanced phonetic information item may be registered beforehand in the dictionary 201. In that case, the entry word data retained in the entry word data retaining section 204 as a result of search by the dictionary search section 203 will include, for example, parts of speech, definitions, examples, as well as the advanced phonetic information and the simple phonetic information. Therefore, processing by the simple phonetic information generation section 205 will not be needed.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

The present invention is not limited to the above embodiments and various changes and modifications can be made within the spirit and scope of the present invention. Therefore, to appraise the public of the scope of the present invention, the following claims are made.

### CLAIM OF PRIORITY

This application claims priority from Japanese Patent Application No. 2004-231425 filed on Aug. 6, 2004, the entire contents of which are hereby incorporated by reference herein.

What is claimed is:

1. An electronic dictionary apparatus comprising:
a storage means for storing a plurality of entry words and advanced phonetic information corresponding to each of the plurality of entry words;
an acquisition means for acquiring the advanced phonetic information corresponding to an entry word specified by a user from the storage means;
a display means for displaying simple phonetic information generated based on the acquired advanced phonetic information; and
a speech output means for performing speech synthesis based on the acquired advanced phonetic information and outputting the synthesized speech.

2. An electronic dictionary apparatus comprising:
a storage means for storing a plurality of entry words and advanced and simple phonetic information corresponding to each of the plurality of entry words;
an acquisition means for acquiring the advanced and simple phonetic information corresponding to an entry word specified by a user from the storage means;
a display means for displaying the acquired simple phonetic information; and
a speech output means for performing speech synthesis based on the acquired advanced phonetic information and outputting the synthesized speech.

3. The electronic dictionary apparatus according to claim 1, wherein the advanced phonetic information conforms to IPA (International Phonetic Alphabet).

4. A method for controlling an electronic dictionary apparatus, comprising the steps of:
acquiring advanced phonetic information corresponding to an entry word specified by a user from a storage means that contains entry words and advanced phonetic information corresponding to each entry word;
displaying simple phonetic information generated based on the acquired advanced phonetic information on a display; and
performing speech synthesis based on the acquired advanced phonetic information and outputting the synthesized speech.

5. A method for controlling an electronic dictionary apparatus, comprising the steps of:
acquiring advanced and simple phonetic information corresponding to an entry word specified by a user from a storage means that contains entry words and advanced and simple phonetic information corresponding to each entry word;
displaying the acquired simple phonetic information on a display; and
performing speech synthesis based on the acquired advanced phonetic information and outputting the synthesized speech.

6. A program for implementing the method according to claim 4 with a computer.
